(19) United States
(12) Patent Application Publication
(10) Pub. No.: US 2025/0209498 A1
(43) Pub. Date: Jun. 26, 2025

(54) METHOD FOR PROVIDING INFORMATION AND VEHICLE FOR CARRYING OUT SAME

(71) Applicants: HYUNDAI MOTOR COMPANY, SEOUL (KR); KIA CORPORATION, SEOUL (KR)

(72) Inventor: Su Jin Kwon, Hwaseong-si (KR)

(73) Assignees: HYUNDAI MOTOR COMPANY, SEOUL (KR); KIA CORPORATION, SEOUL (KR)

(21) Appl. No.: 18/771,132

(22) Filed: Jul. 12, 2024

(30) Foreign Application Priority Data
Dec. 20, 2023 (KR) 10-2023-0186908
Apr. 22, 2024 (KR) 10-2024-0053549
Jul. 4, 2024 (KR) 10-2024-0088469

(51) Int. Cl. G06Q 30/0251; G01C 21/36

(52) U.S. Cl. CPC G06Q 30/0265; G01C 21/3697; G06Q 30/0269

(57) ABSTRACT

A method for providing suitable advertising information in view of a passenger includes providing advertising information including a brand advertisement by an industry associated with the occupant of the seat, based on boarding information and loading information including the category of the occupant of the seat, in a case where there is an object, a child, and a pet on a passenger seat or back seat, and a vehicle for performing the same.

### CROSS REFERENCE TO RELATED APPLICATIONS

The present application claims priority to Korean Patent Application No. 10-2023-0186908, filed on Dec. 20, 2023, Korean Patent Application No. 10-2024-0053549, filed on Apr. 22, 2024, and Korean Patent Application No. 10-2024-0088469, filed on Jul. 4, 2024, the entire contents of which are incorporated herein for all purposes by this reference.

### BACKGROUND

### 1. Field

The present disclosure relates to an information providing method for providing information to passengers of a vehicle and a vehicle for carrying out the same.

### 2. Description of Prior Art

A conventional navigation system installed in a vehicle shows the current location and traveling direction of the vehicle through a display device by using information received from a global positioning system (GPS) satellite, and provides a screen displaying a road on which the vehicle needs to travel, the distance by which the vehicle needs to travel, and the estimated time for which the vehicle needs to travel based on the current location when a destination is input.

This route display function provides more optimized route information by using real-time traffic information, and even provides a multimedia content playback function.

Recently, as a user stays in a vehicle for a long time, functions of improving user convenience by using a navigation system, for example, advertising information about stores near a route, may be provided.

Such advertising information is generally based on a vehicle driver or a vehicle driving route.

The foregoing described as the background art is intended merely to aid in the understanding of the background of the present disclosure, and is not intended to mean that the present disclosure falls within the purview of the related art already known to those skilled in the art.

### SUMMARY

Various aspects of the present disclosure are to providing suitable advertising information in view of a passenger by providing advertising information including a brand advertisement by industry associated with an occupant of each seat or an object loaded on the seat, based on boarding information including the category of the occupant of the seat or loading information about the object loaded on the seat, in a case where there is an object, a child, and a pet on a passenger seat or back seat or there is an object loaded on the seat.

The technical subjects pursued in the present disclosure may not be limited to the above-mentioned technical subjects, and other technical subjects which are not mentioned may be clearly understood, through the following descriptions, by those skilled in the art to which the present disclosure pertains.

In view of the foregoing, a method for providing information according to an embodiment of the present disclosure may include transmitting, by a vehicle, boarding information including a category of an occupant of each seat to a server, and outputting advertising information determined based on the boarding information and loading information about the object loaded on the seat, received from the server, through an output device.

For example, the method may further include collecting the boarding information and loading information through a vehicle sensor including at least one of a short-range sensor and a microphone.

For example, the category of the occupant of the seat may include at least one of an adult, a child, and a pet.

For example, the advertising information may include a brand advertisement by industry associated with the occupant of the seat or loading information about the object loaded on the seat.

For example, the output device may include a display device, and the outputting may include outputting the advertising information through the display device.

For example, the outputting may include outputting the advertising information on a map displayed on the display device.

Further, in view of the foregoing, a method for providing information according to an embodiment of the present disclosure may include receiving, by a server, boarding information including a category of an occupant of each seat from a vehicle and loading information about the object loaded on the seat, and transmitting advertising information determined based on the boarding information and loading information to the vehicle.

For example, the received boarding information and loading information may be collected through a vehicle sensor including at least one of a short-range sensor and a microphone of the vehicle.

For example, the category of the occupant of the seat may include at least one of an adult, a child, and a pet.

For example, an output device of the vehicle may include a display device, and the transmitting may include transmitting the advertising information to the vehicle so that the advertising information is output through the display device of the vehicle.

For example, the transmitting may include transmitting the advertising information to the vehicle so that the advertising information is output on a map displayed on the display device.

For example, the advertising information may include a brand advertisement by industry associated with the occupant of the seat or loading information about the object loaded on the seat.

For example, the method may further include determining the brand advertisement by industry associated with the occupant of the seat, based on the received boarding information and loading information.

In view of the foregoing, a method for providing information according to an embodiment of the present disclosure may include transmitting, by a vehicle, boarding information including a category of an occupant of each seat to a server or loading information about the object loaded on the seat, and outputting advertising information determined based on the boarding information and loading information, received from the server, through an output device.

For example, the method may further include collecting the boarding information and loading information through a vehicle sensor including at least one of an olfactory sensor, a weight-sensitive sensor, a camera, and a microphone.

For example, the category of the occupant of the seat may include at least one of an adult, a child, a pet, an object possessed by the occupant of the seat.

For example, the advertising information may include a brand advertisement by industry associated with the occupant of the seat.

For example, the output device may include a display device, and the outputting may include outputting the advertising information through the display device.

For example, the outputting may include outputting the advertising information on a map displayed on the display device.

Further, to achieve the foregoing aspect, a method for providing information according to an embodiment of the present disclosure may include receiving, by a server, boarding information including a category of an occupant of each seat from a vehicle or loading information about the object loaded on the seat, and transmitting advertising information determined based on the boarding information and loading information to the vehicle.

For example, the received boarding information and loading information may be collected through a vehicle sensor including at least one of an olfactory sensor, a weight-sensitive sensor, a camera, and a microphone of the vehicle.

For example, the category of the occupant of the seat may include at least one of an adult, a child, a pet, an object possessed by the occupant of the seat.

For example, an output device of the vehicle may include a display device, and the transmitting may include transmitting the advertising information to the vehicle so that the advertising information is output through the display device of the vehicle.

For example, the transmitting may include transmitting the advertising information to the vehicle so that the advertising information is output on a map displayed on the display device.

For example, the advertising information may include a brand advertisement by industry associated with the occupant of the seat or the object loaded on the seat.

For example, the method may further include determining the brand advertisement by industry associated with the occupant of the seat, based on the received boarding information and loading information.

In view of the foregoing, a vehicle according to an embodiment of the present disclosure may include an output device and a controller configured to perform control to transmit, by a vehicle, boarding information including a category of an occupant of each seat or loading information about the object loaded on the seat to a server, and to output advertising information determined based on the boarding information and loading information, received from the server, through the output device.

For example, the category of the occupant of the seat may include at least one of an adult, a child, a pet, an object possessed by the occupant of the seat.

For example, the advertising information may include a brand advertisement by industry associated with the occupant of the seat.

For example, the vehicle may further include a vehicle sensor including at least one of an olfactory sensor, a weight-sensitive sensor, a camera, and a microphone, and the controller may be configured to perform control to collect the boarding information including the category of the occupant of the seat or loading information about the object loaded on the seat through the vehicle sensor.

For example, the output device may include a display device, and the controller may be configured to control the output device to output the advertising information through the display device.

For example, the controller may be configured to control the output device to output the advertising information on a map displayed on the display device.

It is possible to provide suitable advertising information in view of a passenger by providing advertising information including a brand advertisement by industry associated with an occupant of each seat, based on boarding information including the category of the occupant of the seat or loading information about the object loaded on the seat, in a case where there is an object, a child, and a pet on a passenger seat or back seat or there is an object loaded on the seat.

Advantageous effects obtainable from the present disclosure may not be limited to the above-mentioned effects, and other effects which are not mentioned may be clearly understood, through the following descriptions, by those skilled in the art to which the present disclosure pertains.

### BRIEF DESCRIPTION OF THE FIGURES

The above and other aspects, features, and advantages of the present disclosure will be more apparent from the following detailed description taken in conjunction with the accompanying drawings, in which:

FIG. 1 illustrates a configuration of a vehicle and operations of the vehicle and a server according to an embodiment of the present disclosure;

FIG. 2 illustrates an example of advertising information displayed on an output device according to an embodiment of the present disclosure;

FIG. 3 is a flowchart illustrating an example of an information providing method of a vehicle according to an embodiment of the present disclosure; and

FIG. 4 is a flowchart illustrating an example of an information providing method of a server according to an embodiment of the present disclosure.

### DETAILED DESCRIPTION

In describing embodiments disclosed in the present specification, when the detailed description of the relevant known technology is determined to unnecessarily obscure the gist of the present disclosure, the detailed description may be omitted. Furthermore, the accompanying drawings are provided only for easy understanding of the embodiments disclosed in the present specification, and the technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

Hereinafter, embodiments disclosed in the present specification will be described in detail with reference to the accompanying drawings, and the same or similar elements are given the same and similar reference numerals, so duplicate descriptions thereof will be omitted.

The present disclosure relates to an information providing method for providing suitable advertising information in view of a passenger, that is, an occupant of each seat, by providing advertising information including a brand advertisement by industry associated with the occupant of the seat or an object loaded on the seat, based on boarding information including the category of the occupant of the seat or loading information about the object loaded on the seat, in a case where there is an object, a child, and a pet on a passenger seat or back seat or there is an object loaded on the seat, and a vehicle for performing the same.

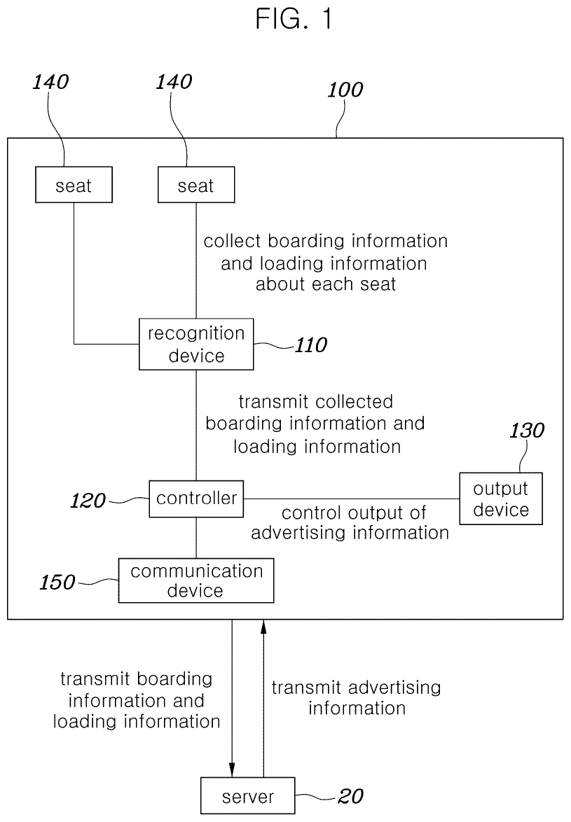

FIG. 1 illustrates a configuration of a vehicle and operations of the vehicle and a server according to an embodiment of the present disclosure.

Referring to FIG. 1, the vehicle according to an embodiment of the present disclosure may include a recognition device 110, a controller 120, an output device 130, a seat 140, and a communication device 150. FIG. 1 mainly shows components related to the embodiment of the present disclosure, and an actual vehicle may include fewer or more components than the described components.

Hereinafter, each component will be described.

The recognition device 110 may be provided in an internal space of the vehicle. For example, the recognition device 110 may include a vehicle sensor provided in the internal space of the vehicle, for example, a sensor capable of obtaining information about an occupant of each seat or an object loaded on the seat, such as an olfactory sensor, weight-sensitive sensor, a camera, and a microphone. However, these sensors are for illustration, and the present disclosure is not necessarily limited thereto.

The recognition device 110 may collect boarding information about each seat occupant sitting in the seat and loading information about an object loaded on the seat, such as a passenger seat or a back seat. The collected information may be transmitted to the controller 120. For example, when a smell detected by the olfactory sensor corresponds to a pet, the controller 120 may determine that the occupant of the seat is a pet. Further, the controller 120 may determine the occupant of the seat by determining whether a weight detected by the weight-sensitive sensor is within the general range of the weight of a pet (e.g., within 10 kg), the weight of a child (e.g., 10 to 30 kg), or the weight of an adult (e.g., more than 40 kg). In addition, the controller 120 may determine the category of the seat occupant or an item possessed by the seat occupant through the size or a behavior pattern of the seat occupant or object recognition through an image captured by the camera, and controller 120 may determine The category of the objects loaded on the seat based on the shape and other characteristics of the object loaded on the seat. In a case of the microphone, the controller 120 may determine the category of the seat occupant, based on the band of a collected sound (e.g., a sound of a pet barking or a vocal range of a child).

Additionally, the controller 120 can determine the category of the objects loaded on the seat through the recognition device 110 in response that the seat is folded and objects are loaded on the folded seat, due to reasons such as camping or moving.

The controller 120 may separately use each piece of information of the recognition device 110 or may combine two or more pieces of information to determine the category of the seat occupant or the item possessed by the seat occupant or the object loaded on the seat.

In configuring the controller 120 according to an embodiment of the present disclosure, the controller 120 may be configured as a function of an audio/video/navigation (AVN) system provided in the vehicle. However, this example is for illustration, and the present disclosure may not necessarily be limited thereto. For example, the controller 120 may be configured as a separate controller from an AVN controller, or may be configured in such a form that functions are distributed in two or more different controllers.

The controller 120 according to an embodiment of the present disclosure may control the boarding information about the seat occupant or loading information about or an object loaded on the seat collected by the recognition device 110 to be transmitted to the server 20, and may control advertising information received from the server 20 to be output.

The output device 130 outputs the advertising information received from the server under control of the controller 120. The output device 130 includes a display device.

For example, the output device 130 may include a cluster and a HUD (Head-Up Display).

The seat 140 can be occupied by a passenger and can also load an object.

Specifically, the object can be loaded on a folded seat, and the object can also be loaded on a seat that is not folded. The communication device 150 can transmit the boarding information or loading information to the server 20 under the control of the controller 120, and receive advertising information from the server 20.

For example, the communication device (150) may be a device that uses communication networks such as cellular networks, Wi-Fi, and Bluetooth.

The server 20 may determine advertising information based on the boarding information about the seat occupant or loading information about an object loaded on the seat, based on the boarding information and loading received from the vehicle. The server 20 may transmit the advertising information based on the boarding information and loading information to the vehicle 100.

Hereinafter, an operation process of the vehicle and the server according to an embodiment of the present disclosure will be described in detail.

In FIG. 1, it is assumed that there is an occupant there is an loaded object on the seat 140 of the vehicle.

For example, it can be assumed that a pet is seated on the seat, or a pet cage is loaded on the folded seat. However, these assumptions are for illustration, and the present disclosure is not necessarily limited thereto.

As described above, boarding information about the occupant positioned or loading information about an object loaded on the seat in the seat 140 of the vehicle, that is, boarding information about an occupant of each seat or loading information about an object loaded on the seat, may be collected by the recognition device 110 provided in the vehicle. The collected information may be transmitted to the server 20.

The boarding information about the occupant of the seat may include category information about the occupant of the seat. The category of the occupant of the seat may include at least one of an adult, a child, a pet, and an object possessed by the occupant of the seat or an object occupying the seat. However, these categories are for illustration, and the present disclosure is not necessarily limited thereto.

The loading information about an object loaded on the seat may include the category information about the object loaded on the seat.

The server 20 may determine advertising information associated with the occupant of the seat or the object loaded on the seat, based on the received boarding information and loading information about the occupant of the seat.

The advertising information may include a brand advertisement by industry associated with the occupant of the seat or the object loaded on the seat. The brand advertisement by industry associated with the occupant of the seat or the object loaded on the seat may be a related brand advertisement including at least one of a baby product and a kids cafe when the category of the occupant of the seat is a child, and may be a brand advertisement including at least one of a veterinary hospital, a pet cafe, and a pet supplies store when the category of the occupant of the seat is a pet. And when the object loaded on the seat is a pet cage, the brand advertisement may include at least one of a veterinary clinic, a pet cafe, or a pet supply store. Further, when the object possessed by the occupant of the seat or the object loaded the seat is food, such as bread or a snack, the brand advertisement may be a cafe-related brand advertisement. However, these examples are for illustration, and the present disclosure is not limited thereto.

The server 20 may transmit the advertising information determined based on the boarding information and loading information about the occupant of the seat to the vehicle 100.

Upon receiving the advertising information determined based on the boarding information about the occupant of the seat or loading information about the object loaded on the seat, the vehicle 100 may control, through the controller 120, the advertising information determined based on the boarding information about the occupant of the seat or loading information about an object loaded on the seat to be output through the output device 130. For example, the controller 120 may control the advertising information determined based on the boarding information about the occupant of the seat or loading information about an object loaded on the seat to be output through the display device included in the output device 130. The advertising information may be output on a map displayed on the display device.

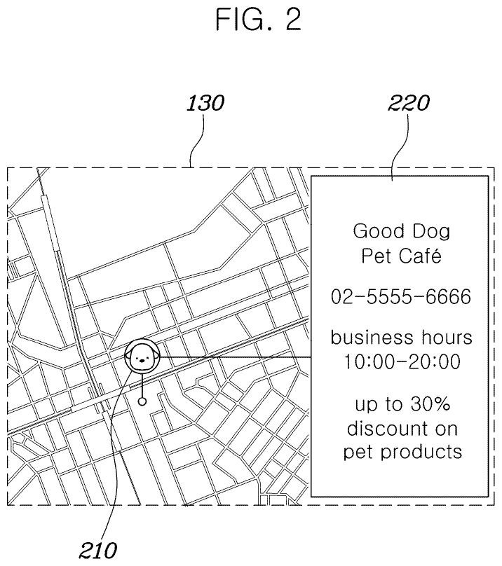

FIG. 2 illustrates an example of advertising information displayed on the output device 130 according to an embodiment of the present disclosure.

In FIG. 2, it is assumed that a pet is sitting in the seat 140 or a pet's cage is loaded on the seat 140.

In this case, the category of an occupant of each seat included in boarding information about the occupant of the seat or loading information about an object loaded on the seat may include a pet.

Advertising information received by the vehicle from the server may be a brand advertisement corresponding to a veterinary hospital, a pet supplies store, a pet cafe, or the like related to the pet.

The controller 120 may control the output device so that the advertising information is displayed on the output device 130. As illustrated in FIG. 2, a display method may be a form of a brand pin 210 positioned on a map displayed on the output device 130. Further, as illustrated in FIG. 2, additional information 220 about a store corresponding to the brand pin 210 may be further displayed. The additional information 220 may include information such as the name of the store, business hours, and discount information. Using the additional information enables a customer to visit the store more conveniently, and may effectively provide the advertising information.

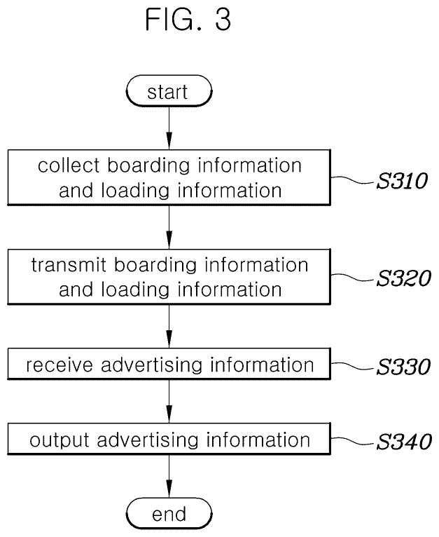

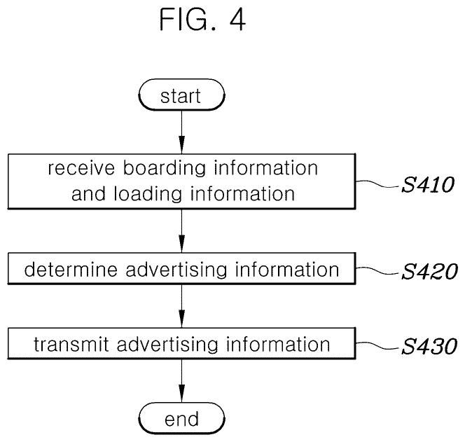

An example of the foregoing information providing process is summarized as in flow charts shown in FIG. 3 and FIG. 4.

FIG. 3 is a flowchart illustrating an example of an information providing method performed in a vehicle according to an embodiment of the present disclosure.

Referring to FIG. 3, the vehicle 100 may collect boarding information about an occupant of each seat or loading information about an object loaded on the seat through a recognition device 110, such as a short-range sensor and a microphone (S310).

As described above, the boarding information about the occupant of the seat may include the category of the occupant of the seat. The category of the occupant of the seat may include at least one of an adult, a child, and a pet. And loading information about an object loaded on the seat may include The category of the object.

The vehicle 100 may transmit the collected boarding information and loading information about the occupant of the seat to a server (S320).

The vehicle 100 may receive advertising information from the server (S330). The advertising information received by the vehicle from the server may include a brand advertisement by industry associated with the occupant of the seat or the object loaded on the seat.

The vehicle 100 may output the received advertising information through an output device 130 (S340). The advertising information determined based on the boarding information about the occupant of the seat or loading information about an object loaded on the seat may be output through a display device included in the output device 130. The advertising information may be displayed on a map displayed on the display device.

FIG. 4 is a flowchart of a server illustrating an example of an information providing method according to an embodiment of the present disclosure.

Referring to FIG. 4, the server 20 may receive boarding information about an occupant of each seat or loading information about an object loaded on the seat from a vehicle 100 (S410). The boarding information about the occupant of the seat or loading information about an object loaded on the seat may include the category of the occupant of the seat. As described above, the category of the occupant of the seat may include at least one of an adult, a child, a pet, and an object possessed by the occupant of the seat or an object occupying the seat. And The loading information about an object loaded on the seat may include the category information about the object loaded on the seat.

The server 20 may determine advertising information associated with the occupant of the seat, based on the received boarding information and loading information of the occupant of the seat (S420).

The advertising information may include a brand advertisement by industry associated with the occupant of the seat or the object loaded on the seat. Since examples of the brand advertisement by industry associated with the occupant of the seat or the object loaded on the seat are the same as above, a redundant description will be omitted.

The server 20 may transmit the determined advertising information to the vehicle (S430).

The advertising information may be transmitted to the vehicle 100 so that the advertising information may be output to an output device 130 of the vehicle. The advertising information may be transmitted to the vehicle 100 so that the advertising information determined based on the boarding information about the occupant of the seat or loading information about an object loaded on the seat is output through a display device included in the output device 130, and may be transmitted so that the advertising information is output on a map displayed in the display device.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like.

The above detailed description should not be construed in a limitative sense, but should be considered in an illustrative sense in all aspects. The scope of the present disclosure should not be determined by reasonable interpretation of the appended claims, and all changes and modifications within the equivalent scope of the present disclosure fall within the scope of the present disclosure.

1. A method for providing information, the method comprising:
transmitting, by a vehicle, boarding information comprising a category of an occupant of each seat or loading information about an object loaded on the seat to a server; and
outputting advertising information through an output device when receiving the advertising information determined based on the boarding information and loading information from the server.

2. The method of claim 1, further comprising collecting the boarding information and loading information through a vehicle sensor comprising at least one of an olfactory sensor, a weight-sensitive sensor, a camera, and a microphone.

3. The method of claim 1, wherein the category of the occupant of the seat comprises at least one of an adult, a child, a pet, an object possessed by the occupant of each seat.

4. The method of claim 1, wherein the advertising information comprises a brand advertisement by an industry associated with the occupant of each seat or the object loaded on the seat.

5. The method of claim 1, wherein the output device comprises a display device, and
wherein the outputting comprises outputting the advertising information through the display device.

6. The method of claim 5, wherein the outputting comprises outputting the advertising information on a map displayed on the display device.

7. A method for providing information, the method comprising:
receiving, by a server, boarding information comprising a category of an occupant of each seat or loading information about the object loaded on the seat from a vehicle; and
transmitting advertising information to the vehicle, wherein the advertising information is determined based on the boarding information and loading information; and
outputting the advertising information in the vehicle.

8. The method of claim 7, wherein the boarding information and loading information is collected through a vehicle sensor comprising at least one of an olfactory sensor, a weight-sensitive sensor, a camera, and a microphone of the vehicle.

9. The method of claim 7, wherein the category of the occupant of each seat comprises at least one of an adult, a child, a pet, an object possessed by the occupant of each seat.

10. The method of claim 7, wherein an output device of the vehicle comprises a display device, and
wherein transmitting comprises transmitting the advertising information to the vehicle so that the advertising information is output through the display device of the vehicle.

11. The method of claim 10, wherein transmitting comprises transmitting the advertising information so that the advertising information is output on a map displayed on the display device.

12. The method of claim 7, wherein the advertising information comprises a brand advertisement by an industry associated with the occupant of each seat or the object loaded on the seat.

13. The method of claim 12, further comprising determining the brand advertisement by the industry associated with the occupant of each seat or the object loaded on the seat, based on the received boarding information and loading information.

14. A vehicle comprising:
an output device; and
a controller configured to transmit boarding information comprising a category of an occupant of each seat or loading information about the object loaded on the seat to a server, and further configured to output advertising information determined based on the boarding information and loading information from the server through the output device.

15. The vehicle of claim 14, wherein the category of the occupant of each seat comprises at least one of an adult, a child, a pet, and an object possessed by the occupant of each seat.

16. The vehicle of claim 14, wherein the advertising information comprises a brand advertisement by an industry associated with the occupant of each seat or the object loaded on the seat.

17. The vehicle of claim 14, further comprising a vehicle sensor comprising at least one of an olfactory sensor, a weight-sensitive sensor, a camera, and a microphone,
wherein the controller is configured to collect the boarding information comprising the category of the occupant of each seat through the vehicle sensor or loading information about the object loaded on the seat.

18. The vehicle of claim 14, wherein the output device comprises a display device, and
wherein the controller is configured to control the output device to output the advertising information through the display device.

19. The vehicle of claim 18, wherein the controller is configured to control the output device to output the advertising information on a map displayed on the display device.
